(19) United States
(12) Patent Application Publication
(10) Pub. No.: US 2017/0325009 A1
(43) Pub. Date: Nov. 9, 2017

(54) Distributed Control For Large Photonic Switches

(71) Applicant: Hamid Mehrvar, Ottawa (CA)

(72) Inventor: Hamid Mehrvar, Ottawa (CA)

(21) Appl. No.: 15/145,850

(22) Filed: May 4, 2016

(51) Int. Cl. H04Q 11/00; H04L 12/947; H04B 10/70

(52) U.S. Cl. CPC H04Q 11/0005; H04L 49/25; H04B 10/70; H04Q 2011/0083; H04Q 2011/009; H04Q 2011/0041

(57) ABSTRACT

Large photonic switches can establish optical paths between a large number of inputs and outputs. A distributed control architecture may be used in order to quickly establish the optical paths in large photonic switches. The distributed control architecture may provide a hierarchical control by grouping together endpoints, determining switching requirements between the groups and determining switching requirements within the groups.

### TECHNICAL FIELD

The current disclosure relates to photonic switches, and in particular to the control of large photonic switches.

### BACKGROUND

Photonic switches may be used to establish optical paths between two end points. FIG. 1 depicts an illustrative optical switch 100 that can establish optical paths between 8 inputs 102a-102h and 8 outputs 104a-104h. The optical paths are established through a switch matrix 106 of individual photonic switching cells. The individual switching cells are controlled in order to establish the desired optical paths through the switch matrix. The switch matrix 106, or more particularly the individual switching cells of the switch matrix, is controlled by a switch controller 108. The switch control 108 receives an indication of the desired optical paths and determines the control signals that need to be generated in order to establish the desired paths.

Unlike electronic switches, which are able to buffer data signals as they arrive at the switch, all-optical switches are not able to buffer the optical signals. The entire optical path must be established between the two end points before data can be transmitted. While small optical switches such as the optical switch 100 may be controlled by a single controller, as switches become larger, the switching components may be separated from each other by a length of cable. As the switch size increases, along with possible increasing optical cable lengths between switching components, the time required to determine and setup the optical paths can become large.

### SUMMARY

In accordance with the present disclosure there is provided a distributed controller for a photonic switch, the photonic switch comprising a plurality of inputs and outputs grouped together into a plurality of groups, the distributed controller comprising: a plurality of group controllers communicatively coupled together, each group controller for controlling switching of inputs and outputs within a respective group; and a switch controller communicatively coupled to the plurality of group controllers, the switch controller for controlling switching between inputs and outputs of the plurality of groups.

In a further embodiment of the distributed controller, the plurality of group controllers communicate desired bandwidth with other groups to an associated group controller of the plurality of group controllers.

In a further embodiment of the distributed controller, the plurality of group controllers determine bandwidth assignments to other groups based on a desired bandwidth from other groups.

In a further embodiment of the distributed controller, the switch controller monitors communication between group controllers to determine required bandwidth between the groups.

In a further embodiment of the distributed controller, one or more of the plurality of group controllers communicate the bandwidth assignments to the switch controller.

In a further embodiment of the distributed controller, the plurality of group controllers are arranged in a ring architecture.

In a further embodiment of the distributed controller, the plurality of group controllers are arranged in a star architecture.

In a further embodiment of the distributed controller, the plurality of group controllers are arranged in a mesh architecture.

In a further embodiment of the distributed controller, the plurality of group controllers are arranged in a tree architecture.

In a further embodiment of the distributed controller, the switch controller is a distributed switch controller comprising a plurality of individual switch controllers in communication with each other.

In a further embodiment of the distributed controller, the distributed switch controller is arranged in one of: a ring architecture with the plurality of group controllers; a mesh architecture; and a tree architecture.

In a further embodiment of the distributed controller, each one of the plurality of group controllers is configured to: determine a desired bandwidth between each of the plurality of groups; send the desired bandwidth as bandwidth requests to the group controllers of the groups; receive bandwidth requests from the group controllers; determine bandwidth assignments to each group based on the received bandwidth requests; send the determined bandwidth assignments to the group controllers; receive bandwidth assignments from the group controllers; and determine switching within the group based on the received bandwidth assignments.

In a further embodiment of the distributed controller, the bandwidth assignment to each group is determined using a fairness scheme or a priority scheme.

In a further embodiment of the distributed controller, each of the plurality of group controllers are further configured to: receive individual bandwidth requests from optical end points of the group, each of the individual bandwidth requests specifying a desired bandwidth to an optical end point coupled to the plurality of inputs and outputs of the photonic switch; and aggregating the individual bandwidth requests to determine the desired bandwidth between each of the plurality of groups.

The distributed controller of claim 1, wherein the distributed controller is within a software defined networking (SDN) controller.

In accordance with the present disclosure there is further provided a method of control of a photonic switch fabric, the photonic switch fabric comprising a plurality of inputs and outputs grouped together into a plurality of groups, each of the plurality of groups associated with a respective group controller of a plurality of group controllers, the method comprising: at each of the plurality of group controllers: controlling switching of inputs and outputs within a respective group; and at a switch controller: controlling switching of inputs and outputs between the plurality of groups.

In a further embodiment, the method further comprises, at each of the plurality of group controllers: determining bandwidth assignments to each group; sending the determined bandwidth assignments to the other group controllers; receiving bandwidth assignments from the other group controllers; and determining switching within the group based on the received bandwidth assignments; and at the switch controller: determining bandwidth assignments between each of the plurality of groups; and determining switching between the groups based on the bandwidth assignments between each of the plurality of groups.

In a further embodiment of the method, the bandwidth assignment to each group is determined using a fairness scheme or a priority scheme.

In a further embodiment, the method further comprises, at each of the plurality of group controllers: determining a desired bandwidth between each of the plurality of groups; sending the desired bandwidth as bandwidth requests to the group controllers of the groups; receiving bandwidth requests from other group controllers; and determining the bandwidth assignments to each group based on the received bandwidth requests.

In a further embodiment of the method, the switch controller determines the bandwidth assignments between each of the plurality of groups by obtaining the determined bandwidth assignments sent from the plurality of group controllers.

In a further embodiment, the method further comprises issuing control signals from the plurality of group controllers to establish the determined switching within the groups.

In a further embodiment, the method further comprises issuing control signals from the switch controller to establish the determined switching between the groups.

### BRIEF DESCRIPTION OF THE DRAWINGS

Embodiments are described herein with reference to the appended drawings, in which:

FIG. 1 depicts a prior-art small photonic switch;

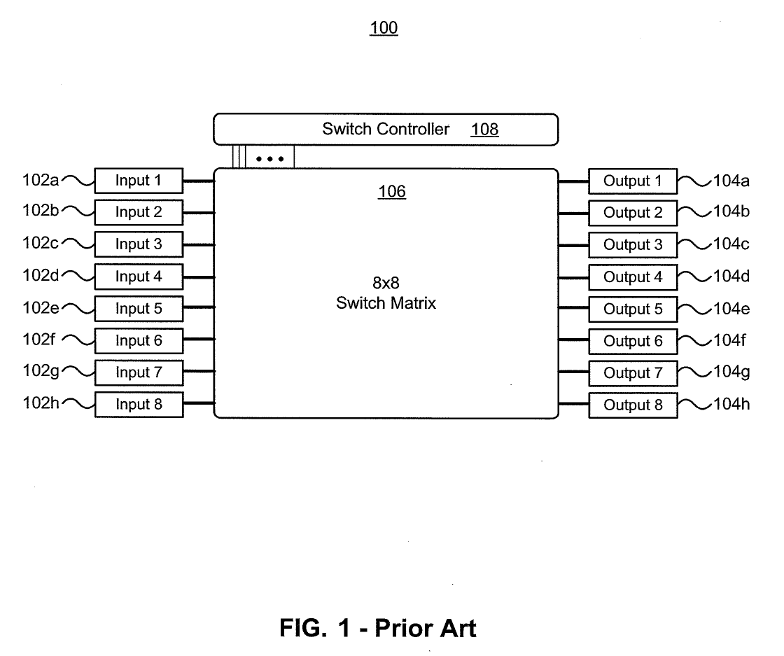

FIG. 2 depicts a large photonic switch;

FIG. 3 depicts a distributed controller of a large photonic switch;

FIG. 4 depicts a distributed control architecture for large photonic switches;

FIG. 5 depicts a further distributed control architecture for large photonic switches;

FIG. 6 depicts a distributed control method for large photonic switches;

FIG. 7 depicts a group controller, and associated method, for use in distributed control of a large photonic switch fabric; and

FIG. 8 depicts portions of a distributed controller.

### DETAILED DESCRIPTION

Photonic switches establish optical paths between end points. Because photonic switches cannot buffer optical signals, it is necessary for the entire optical path from end point to end point to be established prior to transmitting data over the optical path. As the size of optical networks grows, an optical switch may be required to be implemented as a number of separate physical components that are connected together. While such physically distributed switches may be used to provide larger optical networks, centralized control of the switch may reduce an amount of time that can be used for transmitting data since the time required to determine and setup the optical paths may become large for the controller. That is both, the time required to determine the routing for the entire photonic switch by a centralized controller as well as the propagation time to send the determined routing to all of the switching components from the centralized controller increases as the size of the physical switch increases. The propagation time from the centralized controller to the switching components will depend, at least in part, on the length of fiber optic cable or waveguide between the centralized controller and the switching components. While such centralized control may be acceptable for slowly varying optical networks in which optical paths may be setup for hours, days or longer, the time required may be unacceptable, or at least undesirable, for other applications such as in data centers or other networks that have relatively quickly varying optical paths between end points. As described further herein, large photonic switches may be controlled in a distributed manner. Switching end points are grouped together into a plurality of groups. The large photonic switch may be controlled by determining group to group switching connections that provides routing between different groups of end points. Intra group switching may be controlled by a plurality of individual group controllers. Accordingly, groups of end points may be connected together, and then the particular end points within the connected groups may be connected together. Since, the group-to-group connections are likely to change more slowly than the end-point connections, the routing between end points of connected groups can be controlled separately from the group to group connections. As described further below, the photonic switch with distributed control may comprise an agent controller inside of a next generation top of rack switch (NGTOR). NGTORs may be referred to as aggregation nodes, server groups, or end of row switches. The distributed controller further includes group controllers and a switch controller, or a set of group controllers.

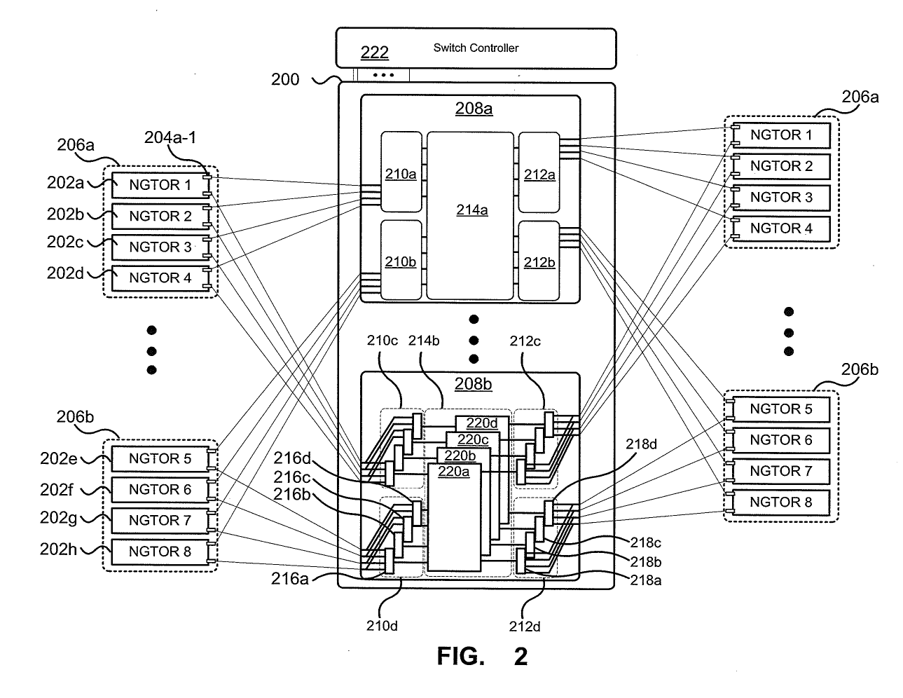

FIG. 2 depicts a large photonic switch. The photonic switch 200 is depicted as an 8×8 switch however, it is possible for the photonic switch to have a much larger capacity, such as 256×256, 512×512, 1024×1024 or larger. Larger switches may be formed by grouping larger capacity switches together with switch controllers in communication with each other in order to provide co-ordinated control of the switches. The photonic switch 200 provides optical switching between end-points, which in FIG. 2 are depicted as next-generation top-of-rack (NGTOR) switches 202a-202h (referred to collectively as NGTORs 202); however, the NGTORs may be provided by other optical switching end points. Each of the NGTORs 202 may be connected to other network components, not depicted, and may aggregate network traffic from connected devices for transmission between other NGTORs 202, or more particularly the network components connected to other NGTORS 202. Each of the NGTORs 202 may have a number of optical interfaces for coupling to the photonic switch 200. The interfaces are depicted as small rectangles, one of which 204a−1 is labelled for NGTOR 202a. Although only a single interface, 204a−1, is labelled, the interfaces are referred to collectively as interfaces 204. Each of the NGTORs 202 is depicted as having 2 interfaces 204; however, it is possible for one or more of the NGTORs 202 to have a different number of interfaces 204.

The individual NGTORs 202 are grouped together into a plurality of end point groups 206a, 206b (referred to collectively as end point groups 206). The number of NGTORs 202 in each of the end point groups 206 are depicted as being the same; however, it is possible for the different end point groups 206 to group together different numbers of NGTORs 202. Further, although only two end point groups 206 are depicted, additional end point groups can be provided. Each of the NGTORs 202 of the end point groups 206 may be connected to the inputs and outputs of the photonic switch 200.

The photonic switch 200 comprises a plurality of sub-switches 208a, 208b (referred to collectively as sub-switches 208). The number of sub-switches 208 forming the switch may correspond to an expected maximum number of interfaces of the NGTORs 202. For example, the NGTORs 202 are depicted as all having 2 interfaces 204 and as such the switch 200 comprises two sub-switches 208. Each of the sub-switches 208 comprise a plurality of end point group input switches 210a, 210b and a plurality of end point group output switches 212a, 212b coupled to each other by a group switching fabric 214a. The end point group switches control switching to NGTORs 202 within the same group. For example, the end point group input switch 210a and end point group output switch 212a switches optical paths to the individual NGTORS 202a-202d of the end point group 206a. The end point group input switch 210b and the end point group output switch 212b switches optical paths to the individual NGTORS 202e-202h of the end point group 206b. The end point group input and output switches 210, 212 can establish connections to the NGTORs 202 within an end point grouping. The group switching fabric 214a establishes connections between the end point group input and output switches 210, 212.

The sub-switch 208b depicts details of the end point group input switches 210 and end point group output switches 212. The end point group input switches, the group switching fabric and the end point group output switches are formed as a plurality of similar switches or switching planes. For example, one switch may be provided by an input switch 216a, coupled to an output switch 218a by a switching fabric 220a. There are similar input switches 216b, 216c, 216d, similar output switches 218b, 218c, 218d and similar switching fabric 220b, 220c, 220d, for each of the NGTORS 202 of the group.

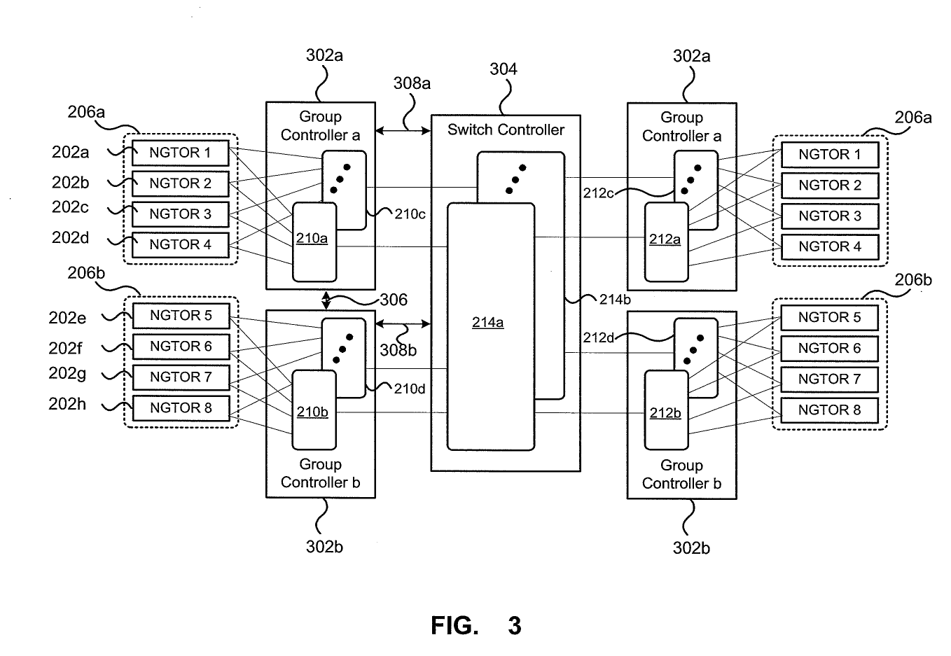

The architecture depicted in FIG. 2 may be used in providing a large photonic switch capable of switching between a large number of end points. The photonic switch 200 is controlled by a switch controller 222 that determines the routing of the optical paths through the photonic switch 200 and applies the control signals to the components of the photonic switch in order to establish the determined routing. In order to determine the routing and establish the optical paths in a reasonable time the switch controller 222 is provided as a distributed controller. As described in further detail with reference to FIG. 3, the distributed controller is provided as a plurality of individual group controllers that control the end point group input and output switches in order to control switching within groups while a main switch controller controls the group switching for switching between groups. Although described as a single switch controller, the switch controller could be implemented in a distributed fashion by a plurality of switch controllers in communication with each other.

FIG. 3 depicts a distributed controller of a large photonic switch. The photonic switch depicted in FIG. 3 comprises a similar architecture as the photonic switch 200 described above; however rather than being aligned one above the other as depicted in FIG. 2 the two sub-switches are stacked one on top of the other. The end point group input switches 210a, 210c coupled to the first group 206a of NGTORs 202 are controlled by a first group controller, namely a group controller a 302a. The group controller a 302a also controls the end point group output switches 212a, 212c coupled to the first group 206a of NGTORs 202. A second group controller, namely group controller b 302b, controls the end point group input switches 210b, 210d and the end point group output switches 212b, 212d associated with the second group 206b of NGTORs 202. The group controllers 302a, 302b control the switch components to provide switching within the groups. A switch controller 304 controls the switching of the connections between the different groups. That is, the switch controller 304 controls the group switching fabric 214a, 214b in order to provide connections between the groups. The switching between groups will tend to vary more slowly than the switching within a group, and as such.

In order to provide coordinated control of the large photonic switch 200 using the plurality of group controllers 302a, 302b and the switch controller 304, each of the NGTORs 202 communicate connection requirements, that is the amount of bandwidth desired to be established with the other NGTORs 202, to the associated group controllers 302a, 302b. The group controllers 302a, 302b communicate the bandwidth requirements with each other as depicted by arrow 306. The connections to be established between the groups of NGTORs 202 is communicated to the switch controller 304, as depicted by arrows 308a, 308b.

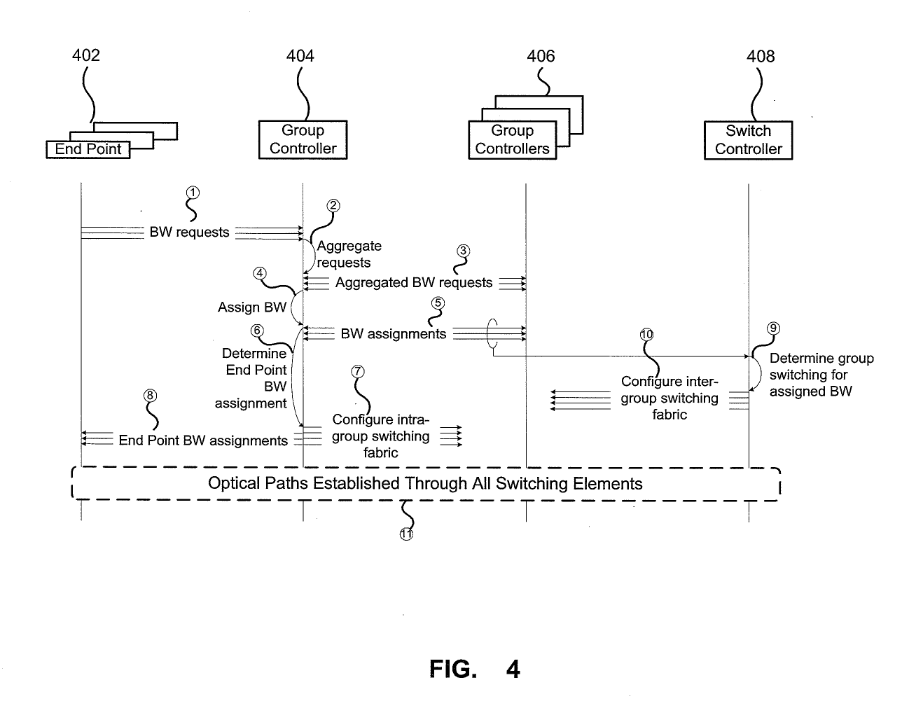

An allocation cycle may be provided in order to determine the bandwidth allocation. During an allocation cycle, which may be relatively short, such as a few microseconds or less, the bandwidth, or bandwidth changes between different groups is determined. The bandwidth may be assigned according to the interfaces of NGTORs. Each member of a group may send a desired bandwidth between itself and other end points to the group controller. The group controllers receive the bandwidth requests from the group members and aggregates the requests together. Each of the group controllers sends the aggregated requests to the other group controllers. The group controllers receive the aggregated requests and determines what bandwidth may be provided. Each of the group controllers provides the determined bandwidth allocations to the other group controllers. When the group controllers receive the bandwidth allocations from other group controllers, the bandwidth is distributed amongst the group members based on the requested bandwidth. The group controllers configure the group switches in order to provide the required connections to the NGTORs. The bandwidth allocated between the groups may be monitored by the switch controller and used in order to configure the switching fabric to provide the connections between groups. The distributed control process is described in further detail below with regard to FIG. 4.

FIG. 4 depicts a process for distributed control of large photonic switches. Messages exchanged between a number of end points 402 associated with a group controller 404 are depicted. Each of the end points 402 may have a number of interfaces, that can be used in providing the bandwidth. For example, the end points 402 may comprise aggregation points that receive data from a plurality of sources, aggregate them together and transmit the data over one of the interfaces. The number of interfaces, and their individual bandwidth capacity, determines the bandwidth capacity of the end point.

Additional group controllers 406 are depicted in FIG. 4. Although not depicted in FIG. 4 it will be appreciated that each of the additional group controllers 406 also perform a similar message exchange with the associated end points 402. A switch control 408 is depicted as monitoring the messages sent between the group controllers 404, 406; however, it is possible for the group controllers 404, 406 to send the messages directly to the switch controller 408.

Each of the end points 402 send bandwidth (BW) requests (1) to the associated group controller 404. The BW requests may provide an indication of the bandwidth that the end point is requesting to be established with other end points connected to the large photonic switch. The group controller 404 receives the BW requests from the end points 402 and aggregates the requests together (2). The aggregated requests provide an amount of bandwidth requested between the group controller 402 and each one of the additional groups 404. Although not depicted, the additional group controllers 406 also receive BW requests from the associated end points 402. The group controllers 404, 406 exchange the aggregated BW requests (3). The Aggregated BW requests are received at the group controller 404 and used in order to assign available bandwidth (4) to each of the groups based on the requested bandwidth. The BW assignments may be determined in various ways including using a fairness scheme such as min-max fairness or a priority scheme. The BW assignments are exchanged between the group controllers (5). The group controller 404 receives the bandwidth assignments from the other group controllers and determines the available bandwidth to be assigned to each of the end points (6). The determined bandwidth assignments for each of the end points is used in order to configure the intra-group switching fabric. That is, the determined bandwidth assignments are by the group controller 404 in order to establish the switching within the group. The group controller 404 may also communicate the bandwidth assignments (8) to the associated end points 402. The BW assignments communicated between the group controllers 404, 406 are monitored by the switch controller 408 and used to determine the group switching required to provide the assigned BW between the different groups (9). The determined group switching is used by the switch controller 408 in configuring the inter-group switching fabric (10). That is, the switch controller 408 configures the switching between groups. Once the intra-group switching fabric and the inter-group switching fabric are configured, the optical paths are established through the photonic switch (11) and data can be transmitted over the optical paths.

The distributed control of large photonic switches described above provides a plurality of group controllers that are inter-connected to each other and to a switch controller. The capacity allocation of the switch by the distributed controller is performed at two levels. The first level is at the group level and may be controlled by the switch controller in order to configure the switch to provide the required bandwidth capacity between the groups. The bandwidth allocation between groups tends to be slowly changing. The second level of control is at the group member level and may be controlled by the group controllers. The group controller determines how to allocate the bandwidth capacity established with other groups by the switch controller to the members within the group. The switch connections are accordingly established at two levels. The switch controller controls switching at the inner, or core, of the photonic switch and provides group to group connectivity. The group controllers control the switching at the outer edge of the photonic switch and provides for the switching to the group members.

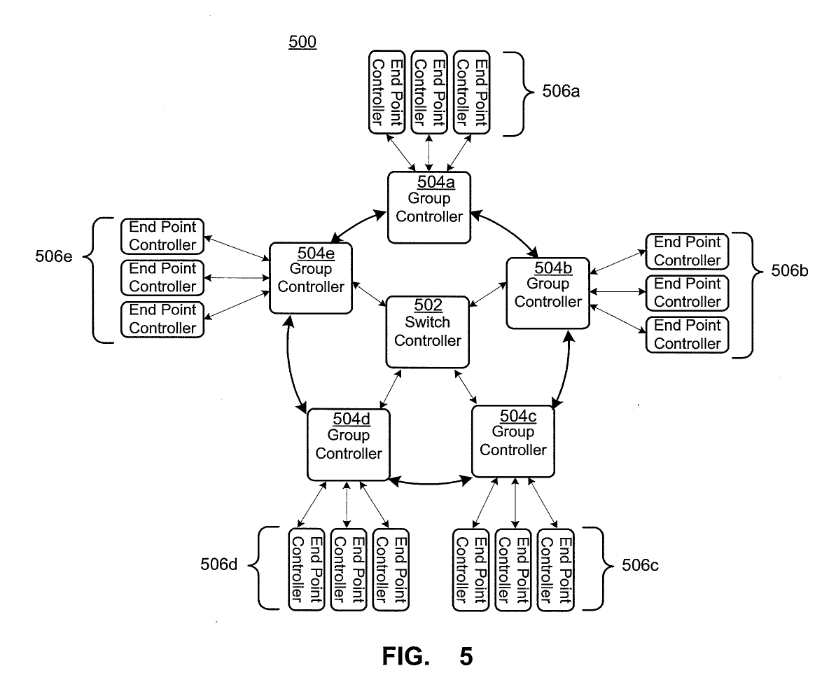

FIG. 5 depicts a distributed control architecture for large photonic switches. The distributed control architecture depicted in FIG. 5 provides hierarchical control of large photonic switches. The distributed control comprises a plurality of group controllers 504a-504e (referred to collectively as group controllers 504) in communication with each other, as well as a switch controller 502 in communication with the group controllers 504, or at least able to receive messages sent between the group controllers. The group controllers 504 are arranged in a ring topology. The group controllers 504 may exchange messages in various ways, depending upon the particular architecture. For example, messages may be sent according to the IEEE 802.17 Resilient Packet Ring (RPR) standard or using a slotted ring approach, where each group controller has a slot of ring bandwidth. The switch controller 502 can read or receive the bandwidth assignments granted by each group controller.

End points, which may be NGTORs as described above, or other optical network end points, connected to the switch may be grouped together into a plurality of end point groups. Each of the end points may be associated with a respective end point controller, which are arranged into end point controller groups 506a-506e. Each of the end point controllers of a particular group are in communication with the group controller for the group. For example, the end point controllers 506a are in communication with group controller 504a. As depicted in FIG. 5, the end point controllers 506a-506e may be in direct communication with the respective group controllers 504.

Communication between the different levels of controllers may be established over a separate control channel, or the communication may be established over the data paths being controlled by the controllers. The group controllers and switch controller can be part of a software defined network (SDN). The distributed control provided by the group controllers and switch controller, which may in turn be a distributed switch controller, may be provided as part of an SDN controller in a datacenter or enterprise application.

The specific architecture of the distributed controller does not need to be limited to the ring topology described above with reference to FIG. 5. Various architectures are possible that provide the required communication between the end point controllers, the group controllers and the switch controller.

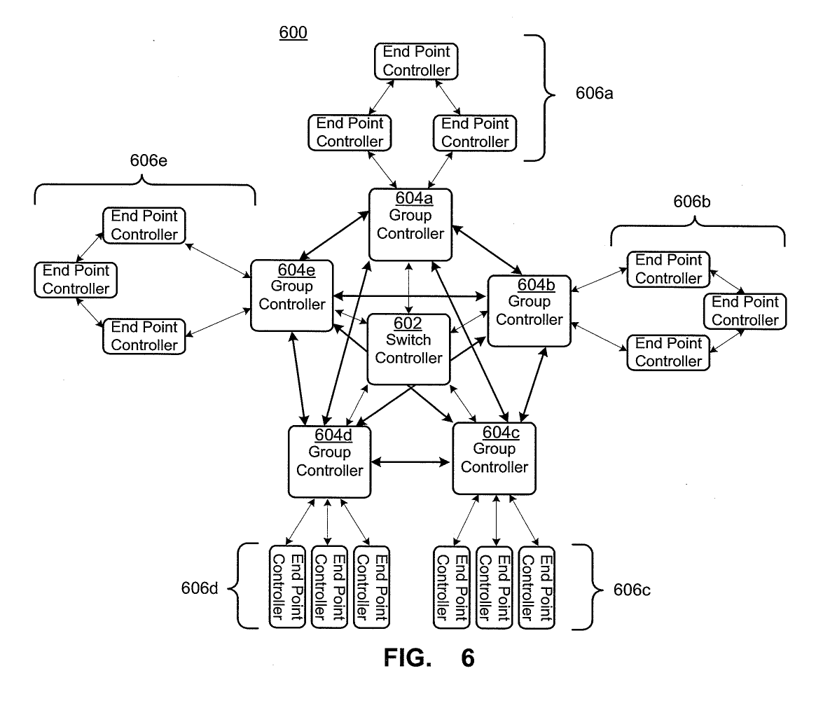

FIG. 6 depicts a further distributed control architecture for large photonic switches. The distributed control architecture 600 comprises a star connection between a switch controller 602 and a plurality of group controllers 604a-604e. The group controllers 604a-604e are in communication with each other through a fully connected mesh architecture. The groups of end points, or end point controllers 606a-606e may also be in communication with the associated group controllers 604a-604e using different architectures, such as a ring architecture as depicted in end point controller groups 606a, 606b, 606e, or directly as depicted in end point controller groups 606c, 606e.

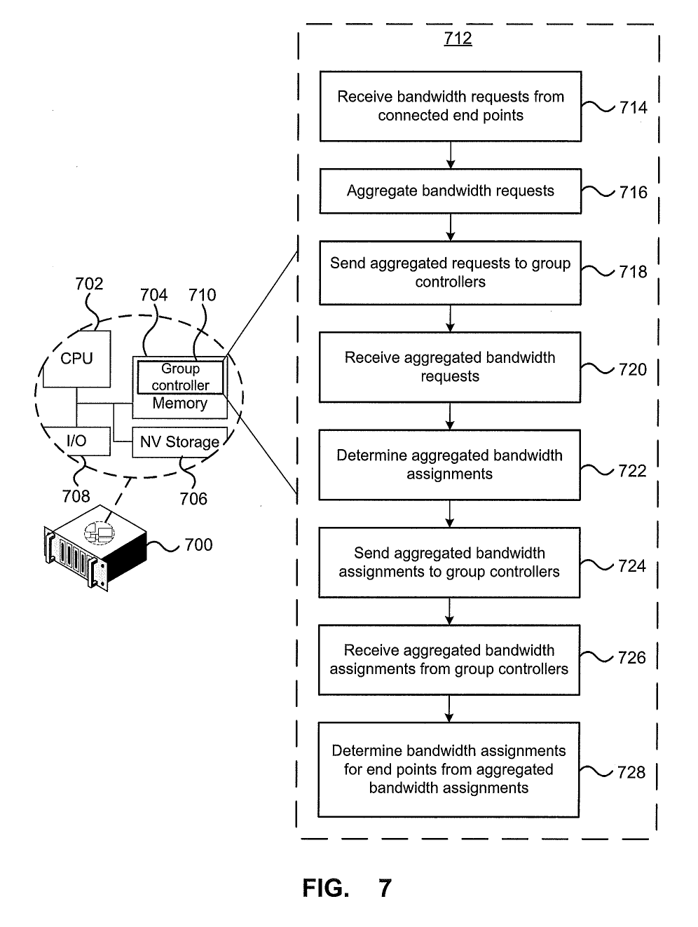

FIG. 7 depicts a group controller, and associated method, for use in distributed control of a large photonic switch fabric. The photonic switch fabric may be provided by one or more individual photonic switches coupled together. The group controller 700 may be used as any of the group controllers described above and may be used to control various large photonic switches of different architectures. Regardless of the particular switch architecture, it is assumed that a plurality of end points connected to the switch are grouped together. The group controller 700 controls the bandwidth assignments, and establishing the appropriate optical paths within a portion of the photonic switch to provide the bandwidth, to end points of the associated group. The group controller is depicted as being provided in a rack type of server case; however, it may be provided in various different physical implementations. The group controller 700 comprises a processor 702 for executing instructions. The instructions may be stored in memory 704 of the group controller 700. In addition to the memory 704, the group controller 700 may include non volatile storage 706. The group controller 700 further comprises one or more input output (I/O) devices 708, such as network interfaces, that allow the group controller to communicate with other components of the distributed controller such as other group controllers or the switch controller as well as other controllers such as end point controllers. The instructions stored in the memory 704 comprise instructions that when executed by the processor 702 configure the group controller 700 to provide group controller functionality 710.

The group controller functionality 710 determines the bandwidth assignments for the end points within the group. A method 712 of controlling end point groups that may be performed by the group controller functionality 710 is depicted in FIG. 7. The method 712 begins with the group controller functionality 710 receiving bandwidth requests from connected end point controllers (714). The bandwidth requests from each of the end point controllers provide an indication of the bandwidth to another end point that is desired. The other end point may be within the same group or within another group. The group controller functionality 710 receives the bandwidth requests and aggregates bandwidth requests (716). The bandwidth requests may be aggregated to provide a total bandwidth requested from the group associated with the group controller 700 to each of the other groups, and may include priority information based on queue levels of the end points. The priority information may be used by group controllers in determining the actual bandwidth assignments. The aggregated bandwidth requests are sent to the other group controllers (718). The other group controllers perform a similar method and as such the other group controllers also send aggregated bandwidth requests to the group controller 700. The group controller functionality 710 receives the aggregated bandwidth requests from the other group controllers (720) and determines the aggregated bandwidth assignments (722) for the different groups. That is, it may not be possible to satisfy requested bandwidth from all of the groups simultaneously, and as such, the group controller determines the bandwidth that will be assigned to the different groups. The determined aggregated bandwidth assignments are sent to each of the group controllers (724). The determined aggregate bandwidth assignments specify the amount of bandwidth that will be provided between the two groups. Again, the other group controllers determine aggregated bandwidth assignments and send them to the other group controllers. The group controller functionality 710 receives the aggregated bandwidth assignments from the other group controllers (726) and determines the bandwidth assignments from the end points within the group (728). That is, once the group-level bandwidth has been assigned between each of the groups, the group controller functionality 710 determines how to allocate the group bandwidth to the end points. Once the end point bandwidth assignments have been determined, the group controller 700 can configure the group switching components to establish the required optical paths. The above group controller functionality may be performed in different orders than described above, however it will be completed within a bandwidth allocation cycle. The length of the bandwidth allocation cycle depends, at least on part, on propagation delay, which could be in the range of for example a micro-second range up to a msec range.

As described above, the group controllers exchange messages allocating bandwidth or capacity between the different groups of end points. The switch controller receives the group bandwidth assignments and configures the switching core in order to establish the required optical paths to provide the group-to-group bandwidth. The switch controller may be provided as a centralized controller, as depicted in FIGS. 5 and 6, or as a distributed controller similar to the group controllers. The plurality of group controllers may be arranged in various architectures, including for example a mesh architecture, a star architecture, a tree architecture and/or a ring architecture. Similarly, the switch controller may be provided as a centralized controller or a distributed architecture, including for example a mesh architecture, a star architecture, a tree architecture and/or a ring architecture.

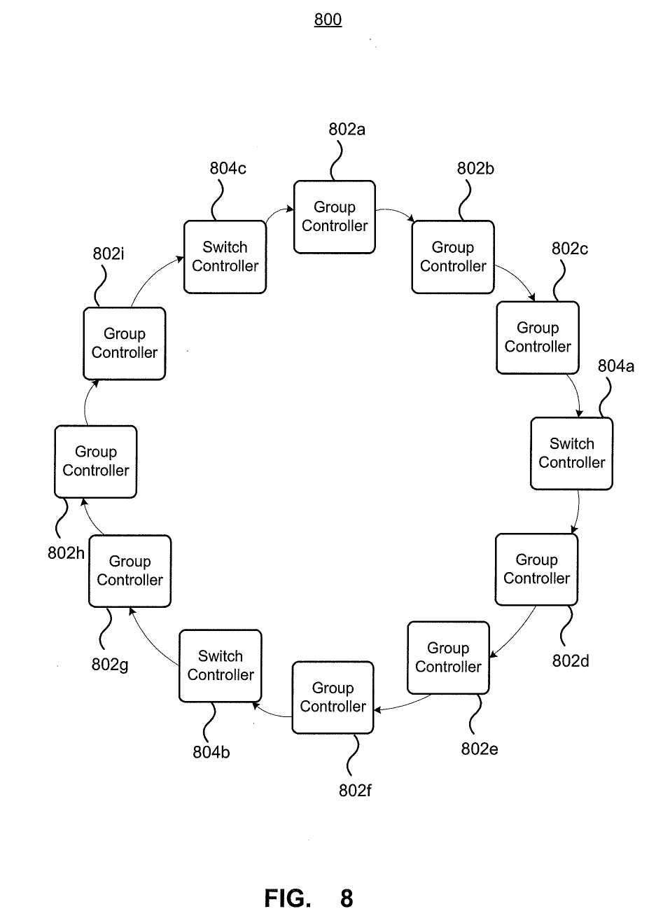

FIG. 8 depicts portions of a distributed controller. The distributed controller 800 depicts only the group controllers 802a-802i (referred to collectively as group controllers 802) and the switch controller which is provided by a number of distributed switch controllers 804a-804c (referred to collectively as switch controllers 804). As depicted, the group controllers 802 and switch controllers 804 are arranged in a ring structure. The specific number of individual group controllers 802 and switch controllers 804 may vary. The functionality of both the group controllers 802 and switch controllers 804 is substantially the same as that described above. As depicted, the group controllers 802 and switch controllers 80 are all part of a ring network. During a bandwidth allocation cycle may be one round trip around the ring. A CONTROL frame may circulate around the ring. FIG. 8 depicts the ring as being uni-directional; however, it is possible for the ring to be bi-directional. Each one of the group controllers 802 can set the allocated bandwidth to the other groups. The allocated bandwidth to a particular group may be placed in a particular location within the CONTROL frame. Each of the group controllers 802 and the switch controllers 804 can read the CONTROL frame in order to determine the bandwidth assignments between each group. The switch controllers 804 may then establish the appropriate optical paths through the optical switches to establish the group-to-group bandwidth and the group controllers 802 can establish the appropriate optical paths to provide the intra-group bandwidth.

The present disclosure provided, for the purposes of explanation, numerous specific embodiments, implementations, examples and details in order to provide a thorough understanding of the invention. It is apparent, however, that the embodiments may be practiced without all of the specific details or with an equivalent arrangement. In other instances, some well-known structures and devices are shown in block diagram form, or omitted, in order to avoid unnecessarily obscuring the embodiments of the invention. The description should in no way be limited to the illustrative implementations, drawings, and techniques illustrated, including the exemplary designs and implementations illustrated and described herein, but may be modified within the scope of the appended claims along with their full scope of equivalents.

While several embodiments have been provided in the present disclosure, it should be understood that the disclosed systems and components might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

What is claimed is:

1. A distributed controller for a photonic switch, the photonic switch comprising a plurality of inputs and outputs grouped together into a plurality of groups, the distributed controller comprising:
a plurality of group controllers communicatively coupled together, each group controller for controlling switching of inputs and outputs within a respective group; and
a switch controller communicatively coupled to the plurality of group controllers, the switch controller for controlling switching between inputs and outputs of the plurality of groups.

2. The distributed controller of claim 1, wherein the plurality of group controllers communicate desired bandwidth with other groups to an associated group controller of the plurality of group controllers.

3. The distributed controller of claim 1, wherein the plurality of group controllers determine bandwidth assignments to other groups based on a desired bandwidth from other groups.

4. The distributed controller of claim 3, wherein the switch controller monitors communication between group controllers to determine required bandwidth between the groups.

5. The distributed controller of claim 2, wherein one or more of the plurality of group controllers communicate the bandwidth assignments to the switch controller.

6. The distributed controller of claim 1, wherein the plurality of group controllers are arranged in a ring architecture.

7. The distributed controller of claim 1, wherein the plurality of group controllers are arranged in a star architecture.

8. The distributed controller of claim 1, wherein the plurality of group controllers are arranged in a mesh architecture.

9. The distributed controller of claim 1, wherein the plurality of group controllers are arranged in a tree architecture.

10. The distributed controller of claim 1, wherein the switch controller is a distributed switch controller comprising a plurality of individual switch controllers in communication with each other.

11. The distributed controller of claim 10, wherein the distributed switch controller is arranged in one of:
a ring architecture with the plurality of group controllers;
a mesh architecture; and
a tree architecture.

12. The distributed controller of claim 1, wherein each one of the plurality of group controllers is configured to:
determine a desired bandwidth between each of the plurality of groups;
send the desired bandwidth as bandwidth requests to the group controllers of the groups;
receive bandwidth requests from the group controllers;
determine bandwidth assignments to each group based on the received bandwidth requests;
send the determined bandwidth assignments to the group controllers;
receive bandwidth assignments from the group controllers; and
determine switching within the group based on the received bandwidth assignments.

13. The distributed controller of claim 12 wherein the bandwidth assignment to each group is determined using a fairness scheme or a priority scheme.

14. The distributed controller of claim 12, wherein each of the plurality of group controllers are further configured to:
receive individual bandwidth requests from optical end points of the group, each of the individual bandwidth requests specifying a desired bandwidth to an optical end point coupled to the plurality of inputs and outputs of the photonic switch; and
aggregating the individual bandwidth requests to determine the desired bandwidth between each of the plurality of groups.

15. The distributed controller of claim 1, wherein the distributed controller is within a software defined networking (SDN) controller.

16. A method of control of a photonic switch fabric, the photonic switch fabric comprising a plurality of inputs and outputs grouped together into a plurality of groups, each of the plurality of groups associated with a respective group controller of a plurality of group controllers, the method comprising:
at each of the plurality of group controllers:
controlling switching of inputs and outputs within a respective group; and
at a switch controller:
controlling switching of inputs and outputs between the plurality of groups.

17. The method of claim 16, further comprising, at each of the plurality of group controllers:
determining bandwidth assignments to each group;
sending the determined bandwidth assignments to the other group controllers;
receiving bandwidth assignments from the other group controllers; and
determining switching within the group based on the received bandwidth assignments; and
at the switch controller:
determining bandwidth assignments between each of the plurality of groups; and
determining switching between the groups based on the bandwidth assignments between each of the plurality of groups.

18. The method of claim 17 wherein the bandwidth assignment to each group is determined using a fairness scheme or a priority scheme.

19. The method of claim 17, further comprising, at each of the plurality of group controllers:
determining a desired bandwidth between each of the plurality of groups;
sending the desired bandwidth as bandwidth requests to the group controllers of the groups;
receiving bandwidth requests from other group controllers; and
determining the bandwidth assignments to each group based on the received bandwidth requests.

20. The method of claim 16, wherein the switch controller determines the bandwidth assignments between each of the plurality of groups by obtaining the determined bandwidth assignments sent from the plurality of group controllers.

21. The method of claim 16, further comprising issuing control signals from the plurality of group controllers to establish the determined switching within the groups.

22. The method of claim 16, further comprising issuing control signals from the switch controller to establish the determined switching between the groups.
